(19) United States
(12) Patent Application Publication
(10) Pub. No.: US 2017/0253031 A1
(43) Pub. Date: Sep. 7, 2017

(54) LIQUID INJECTION DEVICE, INKJET PRINTER, AND METHOD FOR GENERATING DRIVING SIGNAL FOR LIQUID INJECTION DEVICE

(71) Applicant: Roland DG Corporation, Hamamatsu-shi (JP)

(72) Inventors: Kenji KAWAGOE, Hamamatsu-shi (JP); Takashi MAKINOSE, Hamamatsu-shi (JP); Keisuke MISAWA, Hamamatsu-shi (JP)

(21) Appl. No.: 15/450,323

(22) Filed: Mar. 6, 2017

(30) Foreign Application Priority Data
Mar. 7, 2016 (JP) 2016-043176

(51) Int. Cl. B41J 2/045

(52) U.S. Cl. CPC B41J 2/04541; B41J 2/04581

(57) ABSTRACT

A liquid injection device includes a driving signal generation circuit generating a driving signal, and a driving signal supply circuit supplying a portion of, or an entirety of, the driving signal to the actuator. The driving signal generation circuit generates at least one driving pulse included in a dedicated large dot driving signal before a small dot driving signal and a medium dot driving signal. The driving signal supply circuit includes a small dot supplier supplying the small dot driving signal to the actuator; a medium dot supplier supplying the medium dot driving signal, and not supplying the small dot driving signal, to the actuator; and a large dot supplier supplying the small dot driving signal, the medium dot driving signal and the dedicated large dot driving signal to the actuator.

### CROSS REFERENCE TO RELATED APPLICATIONS

This application claims the benefit of priority to Japanese Patent Application No. 2016-043176 filed on Mar. 7, 2016. The entire contents of this application are hereby incorporated herein by reference.

### BACKGROUND OF THE INVENTION

### 1. Field of the Invention

The present invention relates to a liquid injection device, an inkjet printer including the same, and a method for generating a driving signal for the liquid injection device.

### 2. Description of the Related Art

Conventionally, a liquid injection device including a pressure chamber storing a liquid, a vibration plate demarcating a portion of the pressure chamber, an actuator coupled with the vibration plate, a nozzle in communication with the pressure chamber, and a controller supplying a driving signal to the actuator to drive the actuator is known. Such a liquid injection device is provided in, for example, an inkjet printer injecting ink as the liquid.

In an inkjet printer including the liquid injection device, when the controller supplies a driving pulse signal to the actuator, the actuator is deformed. In accordance therewith, the vibration plate is deformed. As a result, the pressure chamber has a capacity thereof increased or decreased, and the pressure of the ink in the pressure chamber is changed. In accordance with the change in the pressure, the ink is injected from the nozzle. The injected ink becomes an ink drop and lands on a recording medium such as a recording paper sheet. As a result, one dot is formed on the recording paper sheet. A great number of such dots are formed on the recording paper sheet, so that an image or the like is formed.

As long as the sizes of such dots are adjusted, a high-quality image is formed on the recording paper sheet. However, with the inkjet printer as described above, there is a limit on the amount of ink which can be stably injected by one driving pulse. It is difficult to form dots of different sizes with one driving pulse. In such a situation, a technology of generating a driving signal including a plurality of driving pulses, and selectively supplying one driving pulse or two or more driving pulses included in the driving signal to the actuator, in a time period that is preset as a time period for forming one dot on a recording paper sheet (hereinafter, such a time period will be referred to as a “driving cycle”) is known.

Japanese Laid-Open Patent Publication No. 2014-162221 discloses an inkjet printer that is capable of forming three types of dots having different sizes, namely, a large dot, a medium dot and a small dot. This inkjet printer forms a driving signal including five driving pulses P1 through P5 at every driving cycle. As shown in FIG. 8A, in order to form a large dot, all the driving pulses P1 through P5 are supplied to the actuator. As shown in FIG. 8B, in order to form a medium dot, the third driving pulse P3 and the fifth driving pulse P5 are supplied to the actuator. As shown in FIG. 8C, in order to form a small dot, only the fifth driving pulse P5 is supplied to the actuator.

In the above-described inkjet printer, the fifth driving pulse P5 is used to form any of a small dot, a medium dot and a large dot. However, in the case where a driving pulse P5 is designed to form a small dot stably, it is not easy to design the other driving pulses such that both of a medium dot and a large dot are formed stably. For this reason, the above-described inkjet printer has a problem that the degree of designing freedom is low.

### SUMMARY OF THE INVENTION

Preferred embodiments of the present invention provide a liquid injection device capable of forming a large dot, a medium dot and a small dot by adjusting a number of driving pulses to be supplied to an actuator, and capable of forming the large dot, the medium dot and the small dot by a driving signal with a high degree of freedom.

A liquid injection device according to a preferred embodiment of the present invention includes a case accommodating a pressure chamber storing a liquid; a vibration plate provided in the case, the vibration plate demarcating a portion of the pressure chamber; an actuator coupled with the vibration plate, the actuator being deformed by an electric signal supplied thereto; a nozzle provided in the case, the nozzle being in communication with the pressure chamber; a driving signal generation circuit generating, at every driving cycle, a driving signal including a small dot driving signal, a medium dot driving signal and a dedicated large dot driving signal, the small dot driving signal, the medium dot driving signal and the dedicated large dot driving signal each including at least one driving pulse; and a driving signal supply circuit supplying a portion of, or an entirety of, the driving signal generated by the driving signal generation circuit to the actuator. The driving signal generation circuit generates the at least one driving pulse included in the dedicated large dot driving signal before the small dot driving signal and the medium dot driving signal. The driving signal supply circuit includes a small dot supplier supplying the small dot driving signal to the actuator; a medium dot supplier supplying the medium dot driving signal, and not supplying the small dot driving signal, to the actuator; and a large dot supplier supplying the small dot driving signal, the medium dot driving signal and the dedicated large dot driving signal to the actuator.

For forming a large dot in the above-described liquid injection device, the dedicated large dot driving signal is supplied to the actuator in addition to the small dot driving signal and the medium dot driving signal. Since the dedicated large dot driving signal is used only to form a large dot, the degree of designing freedom thereof is high.

For forming a medium dot in the above-described liquid injection device, the medium dot driving signal is supplied but the small dot driving signal is not supplied. The small dot driving signal is used to form a small dot and to form a large dot but is not used to form a medium dot. The medium dot driving signal is used to form a medium dot and to form a large dot but is not used to form a small dot. Therefore, the small dot driving signal and the medium dot driving signal may be designed independently from each other. This increases the degree of designing freedom of the driving signal.

With the above-described liquid injection device, the at least one driving pulse included in the dedicated large dot driving signal is generated before the small dot driving signal and the medium dot driving signal. Therefore, there is at least a time period corresponding to the at least one driving pulse included in the dedicated large dot driving signal between the start of the driving cycle and the start of the supply of the small dot driving signal, and between the start of the driving cycle and the start of the supply of the medium dot driving signal. Therefore, even if a meniscus vibration in the immediately previous driving cycle remains at the time of start of the driving cycle, the meniscus vibration is attenuated sufficiently before the small dot driving signal or the medium dot driving signal is supplied. Thus, a small dot and a medium dot are formed stably. Since the small dot and the medium dot are formed stably, the degree of designing freedom of the small dot driving signal and the medium dot driving signal is increased.

With the above-described structure, a liquid injection device capable of forming a large dot, a medium dot and a small dot stably by a driving signal having a high degree of designing freedom is provided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of an inkjet printer.

FIG. 2 is a front view of a portion of the inkjet printer.

FIG. 3 is a cross-sectional view of an injection head.

FIG. 4 is a block diagram of a controller.

FIG. 5 is a waveform diagram of a driving signal.

FIGS. 6A to 6C are each a waveform diagram showing a signal to be supplied to an actuator, and are respectively waveform diagrams of supply signals used to form a small dot, a medium dot and a large dot.

FIG. 7 is a flowchart showing an example of method for designing a driving signal performed by the driving signal generation circuit.

FIGS. 8A to 8C are each a waveform diagram showing a signal to be supplied to an actuator in a conventional inkjet printer, and are respectively waveform diagrams used to form a large dot, a medium dot and a small dot.

### DETAILED DESCRIPTION OF THE PREFERRED EMBODIMENTS

Hereinafter, liquid injection devices and inkjet printers including the same according to preferred embodiments of the present invention will be described with reference to the drawings. The preferred embodiments described herein do not limit the present invention in any way. Components or portions having the same function will bear the same reference signs, and overlapping descriptions will be omitted or simplified.

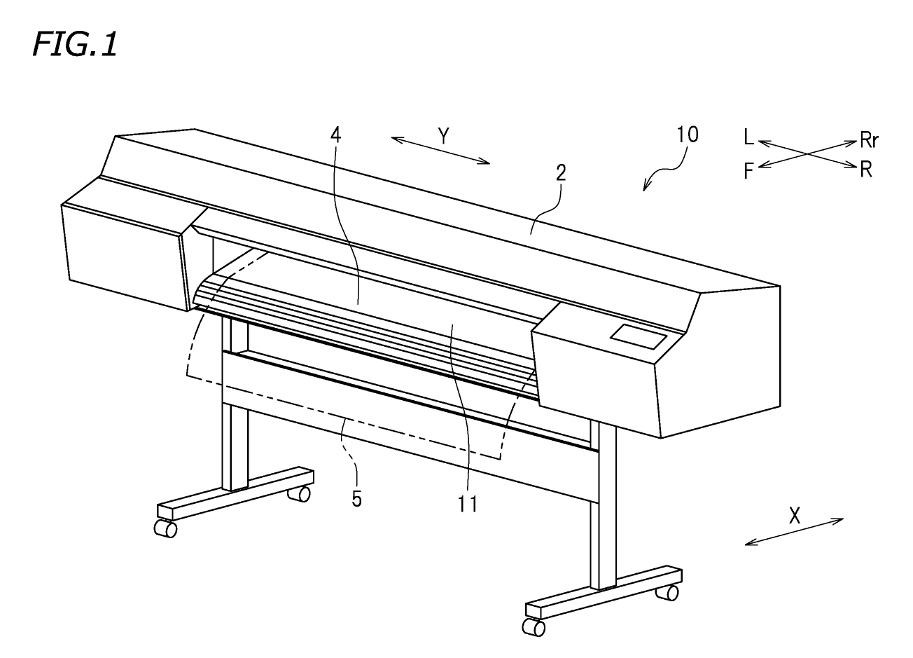

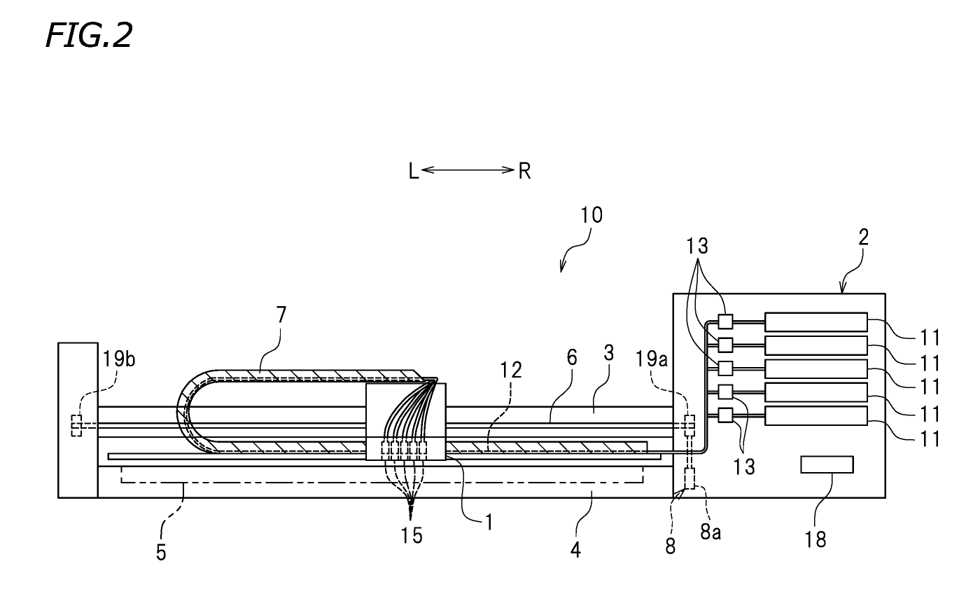

FIG. 1 is a perspective view of an inkjet printer 10 according to a preferred embodiment of the present invention. FIG. 2 is a front view showing a portion of the inkjet printer 10. In FIG. 1 and FIG. 2, the letters “L” and “R” respectively refer to left and right. The letters “F” and “Rr” respectively refer to front and rear. It should be noted that these directions are defined merely for the sake of convenience, and do not limit the manner of installation of the inkjet printer 10 in any way.

The inkjet printer 10 performs printing on a recording paper sheet 5. The recording paper sheet 5 is an example of a recording medium, and is an example of target on which ink is to be injected. The “recording medium” encompasses recording mediums formed of paper including plain paper and the like, resin materials including polyvinyl chloride (PVC), polyester and the like, and various other materials including aluminum, iron, wood and the like.

The inkjet printer 10 includes a casing 2, and a guide rail 3 located in the casing 2. The guide rail 3 extends in a left-right direction. The guide rail 3 is in engagement with a carriage 1 provided with injection heads 15 injecting ink. The carriage 1 moves reciprocally in the left-right direction (scanning direction) along the guide rail 3 by a carriage driver 8. The carriage driver 8 includes pulleys 19a and 19b provided at a right end and a left end of the guide rail 3. The pulley 19a is coupled with a carriage motor 8a. The carriage motor 8a may be coupled with the pulley 19b. The pulley 19a is driven to rotate by the carriage motor 8a. An endless belt 6 extends along, and between, the pulleys 19a and 19b. The carriage 1 is secured to the endless belt 6. When the pulleys 19a and 19b are rotated and thus the belt 6 runs, the carriage 1 moves in the left-right direction.

The inkjet printer 10 preferably is a large inkjet printer, and is larger than, for example, a table-top printer for home use. The scanning speed of the carriage 1 may preferably be occasionally set to be relatively high from the point of view of increasing the throughput although the scanning speed is set also in consideration of resolution. For example, the scanning speed may be preferably set to about 600 mm/s to about 900 mm/s when the driving frequency is about 14 kHz. For, for example, higher-speed operation, the scanning speed may be set to about 1000 mm/s or greater, for example, about 1100 mm/s to about 1200 mm/s, when the driving frequency is about 20 kHz. In such a case, the interval between injections of ink drops is significantly short. Therefore, the technology disclosed herein is especially effective for the inkjet printer 10.

The recording paper sheet 5 is transported in a paper feeding direction by a paper feeding mechanism (not shown). In this example, the paper feeding direction is a front-rear direction. The casing 2 accommodates a platen 4 supporting the recording paper sheet 5. The platen 4 includes a grid roller (not shown). A pinch roller (not shown) is provided above the grid roller. The grid roller is coupled with a feed motor (not shown). The grid roller is driven to rotate by the feed motor. When the grid roller is rotated in a state where the recording paper sheet 5 is held between the grid roller and the pinch roller, the recording paper sheet 5 is transported in the front-rear direction.

The inkjet printer 10 includes a plurality of ink cartridges 11. The plurality of ink cartridges 11 respectively store ink of different colors. For example, the inkjet printer 10 includes five ink cartridges 11 storing cyan ink, magenta ink, yellow ink, black ink and white ink.

The injection heads 15 are respectively provided for the ink of different colors. The injection head 15 and the ink cartridge 11 for each of colors are connected with each other via an ink supply path 12. The ink supply path 12 is an ink flow path usable to supply the ink from the ink cartridge 11 to the injection head 15. The ink supply path 12 is, for example, a flexible tube. A pump 13 is provided on the ink supply path 12. The pump 13 is not absolutely necessary, and may be omitted. A portion of the ink supply path 12 is covered with a cable protection and guide device 7.

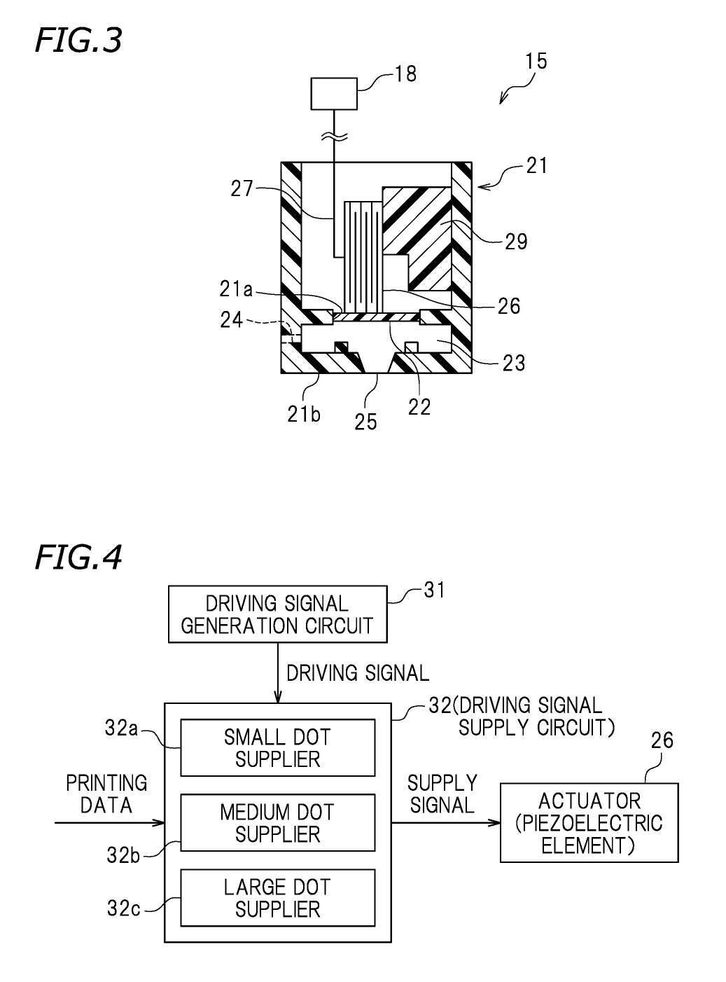

The injection head 15 injects the ink toward the recording paper sheet 5 to form a dot of the ink on the recording paper sheet 5. A great number of such dots are arrayed to form an image or the like. The injection head 15 includes a plurality of nozzles 25 (see FIG. 3) on a surface thereof that faces the recording paper sheet 5 (in this preferred embodiment, on a bottom surface of the injection head 15).

FIG. 3 is a partial cross-sectional view of one nozzle 25 and the vicinity thereof of the injection head 15. As shown in FIG. 3, the injection head 15 includes a hollow case 21 provided with an opening 21a, and a vibration plate 22 attached to the case 21 so as to cover the opening 21a. The vibration plate 22 defines, together with the case 21, a portion of a pressure chamber 23 storing the ink. The vibration plate 22 demarcates a portion of the pressure chamber 23. The vibration plate 22 is elastically deformable to the inside and the outside of the pressure chamber 23. The vibration plate 22 is deformable to increase or decrease the capacity of the pressure chamber 23. The vibration plate 22 is preferably made of a resin film, for example.

A side wall of the case 21 is provided with an ink inlet 24. The ink inlet 24 allows the ink to flow into the case 21. The ink inlet 24 merely needs to be in communication with the pressure chamber 23, and there is no limitation on the position of the ink inlet 24. The pressure chamber 23 is supplied with the ink from the ink cartridge 11 via the ink inlet 24, and stores the ink. The nozzles 25 are provided in a bottom surface 21b of the case 21.

A piezoelectric element 26 is in contact with a surface of the vibration plate 22 opposite to the pressure chamber 23. A portion of the piezoelectric element 26 is secured to a secured member 29. The piezoelectric element 26 is an actuator. The piezoelectric element 26 is connected with the controller 18 via a flexible cable 27. The piezoelectric element 26 is supplied with a signal via the flexible cable 27. In this preferred embodiment, the piezoelectric element 26 preferably is a stacked body including a piezoelectric material layer and a conductive layer stacked alternately. The piezoelectric element 26 is extended or contracted upon receipt of the signal supplied from the controller 18 to act to elastically deform the vibration plate 22 to the inside or to the outside of the pressure chamber 23. In this example, the piezoelectric element 26 is a piezoelectric transducer (PZT) of a longitudinal vibration mode. The PZT of the longitudinal vibration mode is extendable in the stacking direction, and, for example, is contracted when being discharged and is extended when being charged. There is no specific limitation on the type of the piezoelectric element 26.

In the injection head 15 having the above-described structure, the piezoelectric element 26 is contracted by, for example, a decrease in the potential thereof from a reference level. When this occurs, the vibration plate 22 follows this contraction to be elastically deformed to the outside of the pressure chamber 23 from an initial position, and thus the pressure chamber 23 is expanded. The expression that the “pressure chamber 23 is expanded” refers to the capacity of the pressure chamber 23 being increased by the deformation of the vibration plate 22. Next, the potential of the piezoelectric element 26 is increased to extend the piezoelectric element 26 in the stacking direction. As a result, the vibration plate 22 is elastically deformed to the inside of the pressure chamber 23, and thus the pressure chamber 23 is contracted. The expression that the “pressure chamber 23 is contracted” refers to the capacity of the pressure chamber 23 being decreased by the deformation of the vibration plate 22. Such expansion/contraction of the pressure chamber 23 changes the pressure inside the pressure chamber 23. Such a change in the pressure inside the pressure chamber 23 pressurizes the ink in the pressure chamber 23, and the ink is injected from the nozzle 25 as an ink drop. Then, the potential of the piezoelectric element 26 is returned to the reference level, so that the vibration plate 22 returns to the initial position and the pressure chamber 23 is expanded. At this point, the ink flows into the pressure chamber 23 via the ink inlet 24.

The controller 18 is communicably connected with the carriage motor 8a of the carriage driver 8, the feed motor of the paper feeding mechanism, the pump 13, and the injection head 15. The controller 18 controls operations of these components. The controller 18 is typically a computer. The controller 18 preferably includes, for example, an interface (I/F) receiving printing data or the like from an external device such as a host computer or the like, a central processing unit (CPU) executing a command of a control program, a ROM storing the program to be executed by the CPU, a RAM usable as a working area in which the program is developed, and a storage (storage medium) such as a memory or the like storing the above-described program and various other types of data.

As shown in FIG. 4, the controller 18 includes a driving signal generation circuit 31 generating a driving signal to drive the injection head 15, and a driving signal supply circuit 32 supplying a portion of, or the entirety of, the driving signal generated by the driving signal generation circuit 31 to the piezoelectric elements 26 of each of the injection heads 15. In the following description, the piezoelectric element 26 of each injection head 15 will be referred to as an “actuator 26”. A signal supplied by the driving signal supply circuit 32 to the actuator 26 will be referred to as a “supply signal”. As described below in detail, a supply signal is a portion of, or the entirety of, the driving signal generated by the driving signal generation circuit 31.

There is no limitation on the hardware configuration of the driving signal generation circuit 31 or the driving signal supply circuit 32. The driving signal generation circuit 31 and the driving signal supply circuit 32 may each have a well-known hardware configuration (e.g., the hardware configuration disclosed in Japanese Laid-Open Patent Publication No. 2014-162221 mentioned above), which will not be described herein.

As described below, a driving signal generated by the driving signal generation circuit 31 includes a plurality of driving pulses. The driving signal supply circuit 32 selects one driving pulse, or two or more driving pulses, from the plurality of driving pulses, and supplies such a driving pulse(s) to the actuators 26. An appropriate selection of the driving pulse(s) to be supplied to the actuators 26 changes the amount of the ink to be injected from the nozzles 25 of the injection head 15 during one driving cycle. This changes the size of each of dots formed on the recording paper sheet 5. The inkjet printer 10 in this preferred embodiment may form three types of dots having different sizes. In the following description, these three types of dots will be referred to as a “large dot”, a “medium dot” and a “small dot” in the order from the largest dot.

As described below in detail, for forming a small dot, the driving signal supply circuit 32 acts as a small dot supplier 32a supplying a portion of the driving signal to the actuators 26. For forming a medium dot, the driving signal supply circuit 32 acts as a medium dot supplier 32b supplying another portion of the driving signal to the actuators 26. For forming a large dot, the driving signal supply circuit 32 acts as a large dot supplier 32c supplying the entirety of the driving signal to the actuators 26. In this manner, the driving signal supply circuit 32 includes the small dot supplier 32a, the medium dot supplier 32b and the large dot supplier 32c.

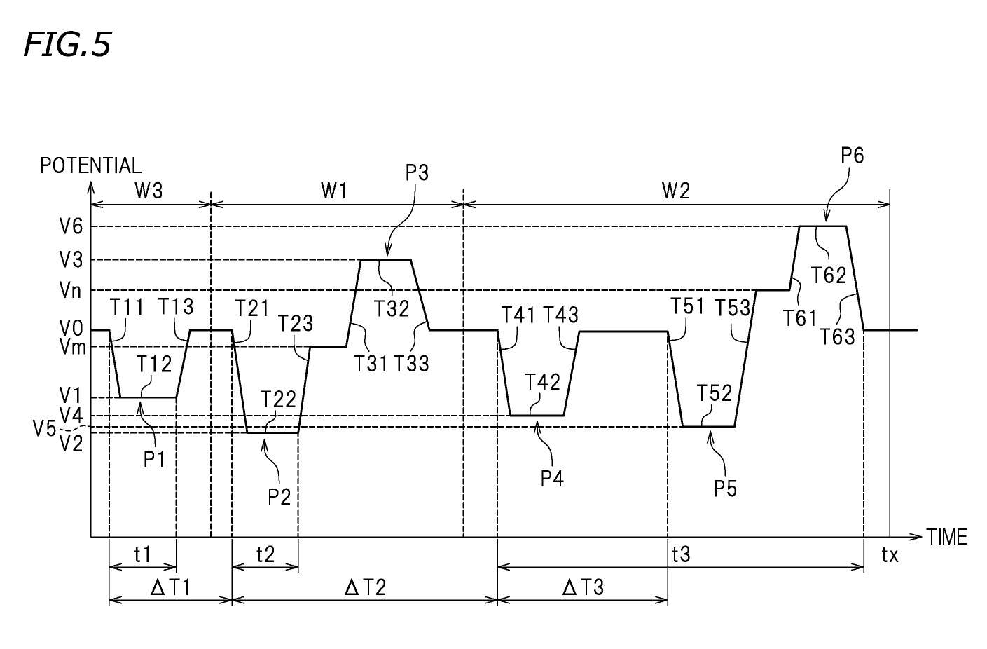

FIG. 5 is a waveform diagram showing a driving signal generated by the driving signal generation circuit 31. The horizontal axis represents the time, and the vertical axis represents the potential. Symbol “tx” represents one driving cycle. The driving signal generation circuit 31 generates the driving signal as shown in FIG. 5 at every driving cycle in repetition.

As shown in FIG. 5, the driving signal includes first through sixth driving pulses P1 through P6. A “driving pulse” is a waveform including a waveform component by which the potential is decreased, a waveform component by which the decreased potential is maintained at the decreased level, and a waveform component by which the maintained potential is increased, or is a waveform including a waveform component by which the potential is increased, a waveform component by which the increased potential is maintained at the increased level, and a waveform component by which the maintained potential is decreased.

This will be described in more detail. The first driving pulse P1 includes a discharge waveform component T11 by which the potential is decreased from reference potential V0 to V1, a discharge maintaining waveform component T12 by which the potential is maintained at V1, and a charge waveform component T13 by which the potential is increased from V1 to V0. The second driving pulse P2 includes a discharge waveform component T21 by which the potential is decreased from V0 to V2, a discharge maintaining waveform component T22 by which the potential is maintained at V2, and a charge waveform component T23 by which the potential is increased from V2 to Vm. The third driving pulse P3 includes a charge waveform component T31 by which the potential is increased from Vm to V3, a charge maintaining waveform component T32 by which the potential is maintained at V3, and a discharge waveform component T33 by which the potential is decreased from V3 to V0. The fourth driving pulse P4 includes a discharge waveform component T41 by which the potential is decreased from V0 to V4, a discharge maintaining waveform component T42 by which the potential is maintained at V4, and a charge waveform component T43 by which the potential is increased from V4 to V0. The fifth driving pulse P5 includes a discharge waveform component T51 by which the potential is decreased from V0 to V5, a discharge maintaining waveform component T52 by which the potential is maintained at V5, and a charge waveform component T53 by which the potential is increased from V5 to Vn. The sixth driving pulse P6 includes a charge waveform component T61 by which the potential is increased from Vn to V6, a charge maintaining waveform component T62 by which the potential is maintained at V6, and a discharge waveform component T63 by which the potential is decreased from V6 to V0. In this preferred embodiment, V6>V3>Vn>V0>Vm>V1>V4>V5>V2. There is no specific limitation on which are larger or smaller among V1, V4, V5 and V2. There is no specific limitation, either, on which is larger or smaller among V6 and V3.

The first driving pulse P1, the second driving pulse P2, the fourth driving pulse P4 and the fifth driving pulse P5 at first increase, and then decrease, the capacity of the pressure chamber 23. In other words, the first driving pulse P1, the second driving pulse P2, the fourth driving pulse P4 and the fifth driving pulse P5 at first decrease, and then increase, the pressure in the pressure chamber 23. The third driving pulse P3 and the sixth driving pulse P6 at first decrease, and then increase, the capacity of the pressure chamber 23. In other words, the third driving pulse P3 and the sixth driving pulse P6 at first increase, and then increase, the pressure in the pressure chamber 23.

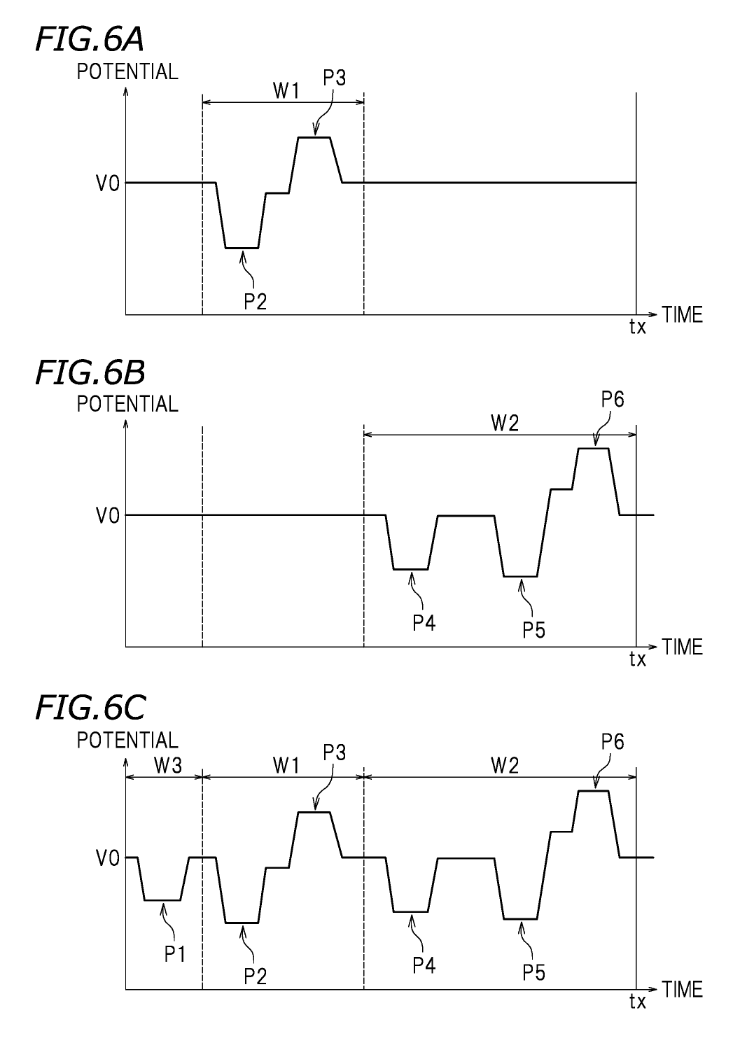

FIG. 6A shows a supply signal that is supplied to the actuator 26 in order to form a small dot. As shown in FIG. 6A, a small dot driving signal W1 includes the second driving pulse P2 and the third driving pulse P3. When the second driving pulse P2 and the third driving pulse P3 are supplied to the actuator 26, the capacity of the pressure chamber 23 is first increased and then is decreased, and an operation of injecting the ink from the nozzle 25 is performed once. As a result, a first amount of ink is injected from the nozzle 25, and a small dot is formed on the recording paper sheet 5.

FIG. 6B shows a supply signal that is supplied to the actuator 26 in order to form a medium dot. As shown in FIG. 6B, a medium dot driving signal W2 includes the fourth through sixth driving pulses P4 through P6. When the fourth driving pulse P4 is supplied to the actuator 26, the capacity of the pressure chamber 23 is first increased and then is decreased, and the operation of injecting the ink from the nozzle 25 is performed once. When the fifth driving pulse P5 and the sixth driving pulse P6 are then supplied to the actuator 26, the capacity of the pressure chamber 23 is first increased and then is decreased, and the operation of injecting the ink from the nozzle 25 is performed once. Namely, when the fourth through sixth driving pulses P4 through P6 are supplied to the actuator 26, the operation of injecting the ink from the nozzle 25 is performed twice in total. As a result, a second amount of ink, which is larger than the first amount of ink, is injected from the nozzle 25, and a medium dot is formed on the recording paper sheet 5.

FIG. 6C shows a supply signal that is supplied to the actuator 26 in order to form a large dot. As shown in FIG. 6C, in order to form a large dot, a dedicated large dot driving signal W3, the small dot driving signal W1 and the medium dot droving signal W2 are supplied to the actuator 26. The dedicated large dot driving signal W3 includes a first driving pulse P1. For forming a large dot, the driving signal supply circuit 32 supplies the first through sixth driving pulses P1 through P6 to the actuator 26. When the first driving pulse P1 is supplied to the actuator 26, the capacity of the pressure chamber 23 is first increased and then is decreased, and the operation of injecting the ink from the nozzle 25 is performed once. When the second driving pulse P2 and the third driving pulses P3 are then supplied to the actuator 26, the capacity of the pressure chamber 23 is first increased and then is decreased, and the operation of injecting the ink from the nozzle 25 is performed once. When the fourth through sixth driving pulses P4 through P6 are then supplied to the actuator 26, the operation of injecting the ink from the nozzle 25 is performed twice as described above. Namely, when the first through sixth driving pulses P1 through P6 are supplied to the actuator 26, the operation of injecting the ink from the nozzle 25 is performed four times in total. As a result, a third amount of ink, which is larger than the second amount of ink, is injected from the nozzle 25, and a large dot is formed on the recording paper sheet 5.

Referring to FIG. 5, the potentials of the driving pulses P1 through P6, the timing of generating the driving pulses P1 through P6, the pulse widths of the driving pulses P1 through P6, and the like are mere examples, and there is no specific limitations thereon. In this preferred embodiment, the following settings are made. A discharge time period (i.e., the sum of the time period in which the actuator 26 is discharged and the time period in which the potential thereof is maintained at the discharge potential) of the first driving pulse P1, namely, discharge time period t1, is preferably set to ½ or about ½ of the Helmholtz characteristic vibration period Tc of the injection head 15, for example. A discharge time period t2 of the second driving pulse P2 is preferably set to ½ or about ½ of the Helmholtz characteristic vibration period Tc, for example. A time period ΔT1 from the start of the first driving pulse P1 to the start of the second driving pulse P2 is preferably set to m×Tc (m is a natural number), for example. A time period ΔT2 from the start of the second driving pulse P2 to the start of the fourth driving pulse P4 is preferably set to (n+(1/2))×Tc (n is a natural number), for example. A time period ΔT3 from the start of the fourth driving pulse P4 to the start of the fifth driving pulse P5 is preferably set to p×Tc (p is a natural number of 2 or greater), for example. The first through sixth driving pulses P1 through 6 are set such that the speed at which a second ink drop is injected by the second driving pulse P2 and the third driving pulse P3 is higher than the speed at which a first ink drop is injected by the first driving pulse P1. The first through sixth driving pulses P1 through 6 are also set such that the speed at which a fourth ink drop is injected by the fifth driving pulse P5 and the sixth driving pulse P6 is higher than the speed at which a third ink drop is injected by the fourth driving pulse P4.

When the first through sixth driving pulses P1 through P6 are supplied to the actuator 26, the first through fourth ink drops are injected from the nozzle 25 during one driving cycle. Before landing on the recording paper sheet 5, the first ink drop and the second ink drop are merged. Then, the third ink drop and the fourth ink drop are merged, and land at the same, or substantially the same, position as that of the first ink drop and the second ink drop already landed. As a result, one dot (large dot) is formed on the recording paper sheet 5.

When the fourth through sixth driving pulses P4 through P6 are supplied to the actuator 26, the third ink drop and the fourth ink drop are injected from the nozzle 25 during one driving cycle. Before landing on the recording paper sheet 5, the third ink drop and the fourth ink drop are merged. As a result, one dot (medium dot) is formed on the recording paper sheet 5.

When the second driving pulse P2 and the third driving pulse 3 are supplied to the actuator 26, the second ink drop is injected from the nozzle 25 during one driving cycle. The second ink drop lands on the recording paper sheet 5. As a result, one dot (small dot) is formed on the recording paper sheet 5.

As shown in FIGS. 6A through 6C, the small dot driving signal W1 is supplied to form a small dot. The medium dot driving signal W2 is supplied to form a medium dot. The small dot driving signal W1 and the medium dot driving signal W2 are also supplied to form a large dot. By contrast, the small dot driving signal W1 is not supplied to form a medium dot, and the medium dot driving signal W2 is not supplied to form a small dot. In this preferred embodiment, the small dot driving signal W1 is generated before the medium dot driving signal W2. Alternatively, the medium dot driving signal W2 may be generated before the small dot driving signal W1.

The dedicated large dot driving signal W3 is supplied only to form a large dot. The dedicated large dot driving signal W3 includes at least one driving pulse. The dedicated large dot driving signal W3 may include a plurality of driving pulses. In this preferred embodiment, the dedicated large dot driving signal W3 includes one driving pulse P1. The dedicated large dot driving signal W3 includes a single driving pulse P1. The at least one driving pulse included in the dedicated large dot driving signal W3 is generated before the small dot driving signal W1 and the medium dot driving signal W2. In this preferred embodiment, only one driving pulse, more specifically, only the first driving pulse P1, is included in the dedicated large dot driving signal W3, and is generated before any of the second through sixth driving pulses P2 through P6 included in the small dot driving signal W1 or the medium dot driving signal W2. The first driving pulse P1 included in the dedicated large dot driving signal W3 is not generated between the small dot driving signal W1 and the medium dot driving signal W2.

The structure of the inkjet printer 10 is described above. Now, an example of a method for designing (generating) a driving signal will be described. The driving signal generation circuit 31 generates a predetermined driving signal. Therefore, designing a driving signal is performed by the driving signal generation circuit 31. The driving signal generation circuit 31 is a portion of the inkjet printer 10. Therefore, the method for designing a driving signal is a portion of the method for designing the inkjet printer 10.

With an example of method for designing a driving signal, first, waveforms of the small dot driving signal W1 and the medium dot driving signal W2 are designed. As described above, in this preferred embodiment, the medium dot driving signal W2 is not supplied to form a small dot. The small dot driving signal W1 is not supplied to form a medium dot. For forming a small dot, only the small dot driving signal W1 is supplied. Therefore, a waveform optimal to form a small dot of a desired size may be set as the waveform of the small dot driving signal W1, with no influence of the waveform of the medium dot driving signal W2. Similarly, only the medium dot driving signal W2 is supplied to form a medium dot. Therefore, a waveform optimal to form a medium dot of a desired size may be set as the waveform of the medium dot driving signal W2, with no influence of the waveform of the small dot driving signal W1. There is no limitation on the order of the design of the small dot driving signal W1 and the medium dot driving signal W2. The small dot driving signal W1 may be first designed, and then the medium dot driving signal W2 may be designed. Alternatively, the medium dot driving signal W2 may be first designed, and then the small dot driving signal W1 may be designed.

Next, a waveform of the dedicated large dot driving signal W3 is designed. More specifically, a waveform of the dedicated large dot driving signal W3 is designed such that a large dot of a predetermined size is formed on the recording paper sheet 5 by supplying, to the actuator 26, a driving signal obtained as a result of the dedicated large dot driving signal W3 being added to the small dot driving signal W1 and the medium dot driving signal W2 designed as described above.

It is relatively easy to independently design the small dot driving signal W1. It is also relatively easy to independently design the medium dot driving signal W2. By contrast, it is not necessarily easy to design a signal to drive the actuator 26 to form a large dot of a predetermined size (see FIG. 6C). Now, the above-described designing method is performed as follows. The waveform of the small dot driving signal W1 and the waveform of the medium dot driving signal W2, which are designed relatively easily, are independently designed and thus the driving signals W1 and W2 are determined. Then, only the dedicated large dot driving signal W3 is adjusted without adjusting the driving signal W1 or W2, so that a signal to be supplied to the actuator 26 in order to form a large dot (see FIG. 6C) is designed. Thus, the waveform of the dedicated large dot driving signal W3 is designed easily. With the above-described designing method, the waveform of the small dot driving signal W1, the waveform of the medium dot driving signal W2, and the waveform of the dedicated large dot driving signal W3 are all designed easily.

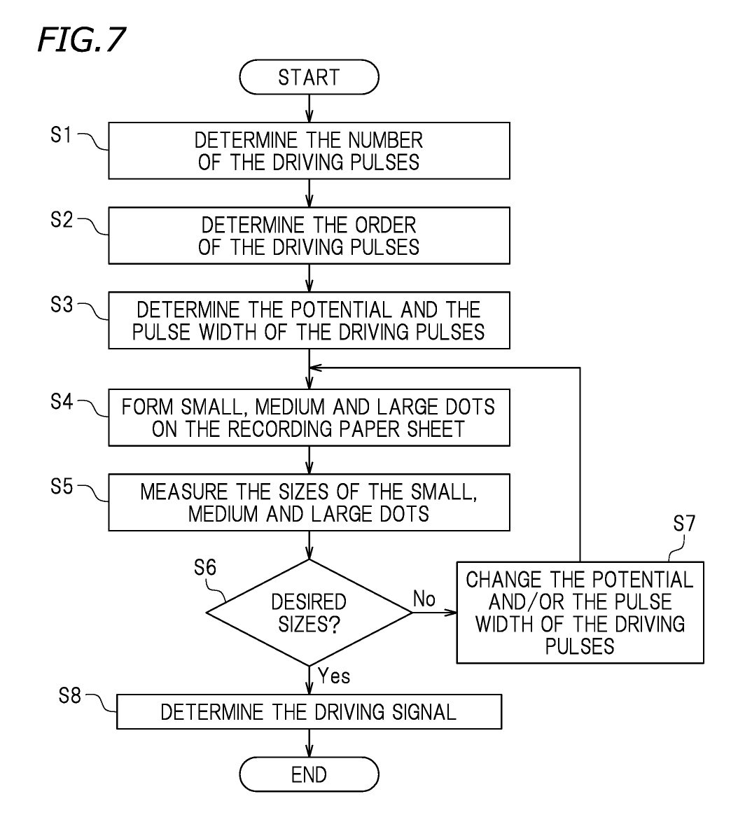

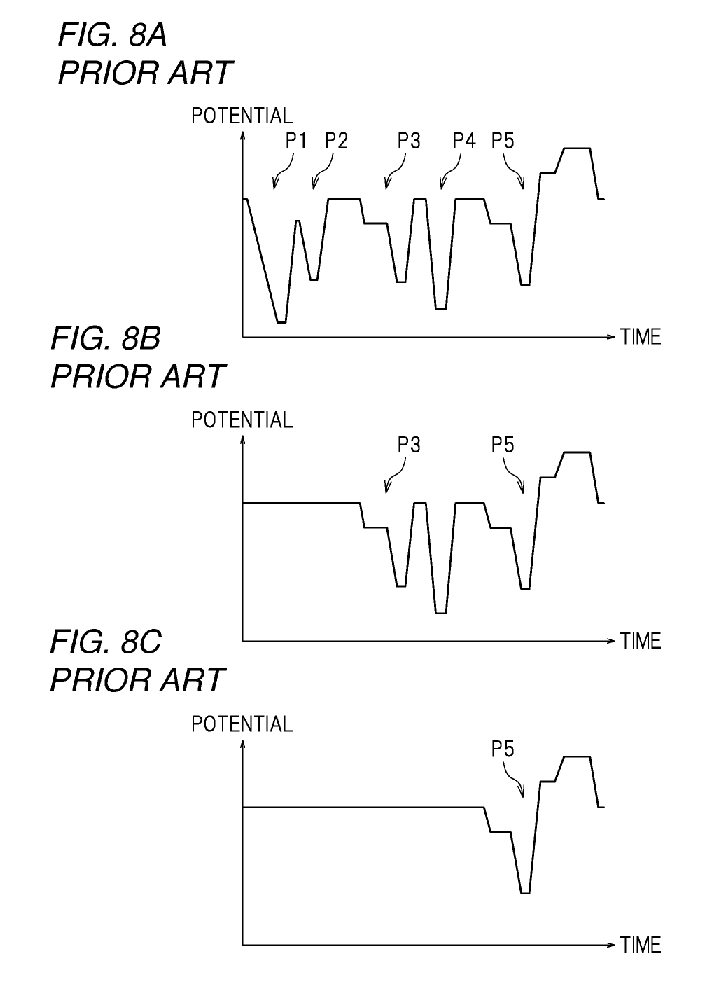

As described above, there is no specific limitation on the potential, the pulse width and the like of each of the driving pulses P1 through P6 included in the driving signal generated by the driving signal generation circuit 31. The potentials, the pulse widths and the like of the driving pulses P1 through P6 may be adjusted based on the sizes of the small dot, medium dot and the large dot formed on the recording paper sheet 5 with the ink actually injected from the injection head 15. Now, with reference to FIG. 7, an example of method for designing the driving signal generation circuit 31 performing such adjustment will be described.

First, the number of the driving pulses to be included in the small dot driving signal W1, the number of the driving pulses to be included in the medium dot driving signal W2, and the number of the driving pulses to be included in the dedicated large dot driving signal W3 are determined (step S1). In this preferred embodiment, the number of the driving pulses to be included in the small dot driving signal W1 is determined as 2, the number of the driving pulses to be included in the medium dot driving signal W2 is determined as 3, and the number of the driving pulses to be included in the dedicated large dot driving signal W3 is determined as 1.

Next, the order of all of the driving pulses to be included in the small dot driving signal W1, the driving pulses to be included in the medium dot driving signal W2, and the driving pulses to be included in the dedicated large dot driving signal W3 is determined (step S2). In this preferred embodiment, the order of the driving pulses P1 through P6 is determined as the driving pulse P1, the driving pulse P2, the driving pulse P3, the driving pulse P4, the driving pulse P5 and the driving pulse P6.

Next, the potential and the pulse width of each of the driving pulses to be included in the small dot driving signal W1, the driving pulses to be included in the medium dot driving signal W2, and the driving pulses to be included in the dedicated large dot driving signal W3 are determined (step S3). In this preferred embodiment, the potential and the pulse width of each of the driving pulses P1 through P6 are determined as shown in FIG. 5.

In this example, steps S1 through S3 are executed in the order of step S1, step S2 and step S3. There is no limitation on the order of the execution of steps S1, S2 and S3. As in the above-described example, the waveforms of the small dot driving signal W1 and the medium dot driving signal W2 may be first determined and then the waveform of the dedicated large dot driving signal W3 may be determined. When steps S1 through S3 are finished, a provisional driving signal is set. Next, this provisional driving signal is used to drive the injection head 15, and a small dot, a medium dot and a large dot are formed on the recording paper sheet 5 (step S4). Then, the size of each of the small dot, the medium dot and the large dot is measured (step S5). Next, it is determined whether the size of each of the small dot, the medium dot and the large dot is a desired size or not (step S6). In the case where, for example, the measured values of the diameter of the small dot, the medium dot and the large dot are respectively is D1, D2 and D3, the set values of the diameter of the small dot, the medium dot and the large dot are respectively d1, d2 and d3, and the tolerable errors are respectively set to α, β and γ, it is determined whether |D1−d1|≦α, |D2−d2|≦β, and |D3−d3|≦γ are satisfied or not. When it is determined that the sizes are not desired sizes, the potential and/or the pulse width of one driving pulse, or two or more driving pulses, among the driving pulses P1 through P6 is changed (step S7). Namely, the potential and/or the pulse width of the driving pulse is adjusted. The post-change driving signal is set as a new provisional driving signal. After step S7, the operation is returned to step S4, and step S4 and thereafter are repeated. By contrast, when it is determined in step S6 that the sizes of the small dot, the medium dot and the large dot are the desired sizes, the provisional driving signal is set as a determined driving signal (step S8), and the designing is finished.

As described above, the inkjet printer 10 in this preferred embodiment generates a driving signal including the small dot driving signal W1, the medium dot driving signal W2 and the dedicated large dot driving signal W3 at every driving cycle. For forming a small dot, the small dot driving signal W1 is supplied to the actuator 26. For forming a medium dot, the medium dot driving signal W2 is supplied to the actuator 26. For forming a large dot, the dedicated large dot driving signal W3, the small dot driving signal W1 and the medium dot driving signal W2 are supplied to the actuator 26. The inkjet printer 10 in this preferred embodiment generates a large dot by a simple technique of adding the dedicated large dot driving signal W3 to the small dot driving signal W1 and the medium dot driving signal W2. Since the dedicated large dot driving signal W3 is used only to form a large dot, the degree of designing freedom of the driving signal is increased.

For forming a medium dot in the inkjet printer 10 in this preferred embodiment, the medium dot driving signal W2 is supplied but the small dot driving signal W1 is not supplied. The small dot driving signal W1 is used to form a small dot and to form a large dot but is not used to form a medium dot. The medium dot driving signal W2 is used to form a medium dot and to form a large dot but is not used to form a small dot. Therefore, the small dot driving signal W1 and the medium dot driving signal W2 may be designed independently from each other. This increases the degree of designing freedom of the driving signal.

After the ink is injected from the nozzle 25, a meniscus vibration is caused in the nozzle 25. Since the operation of injecting the ink is performed at every driving cycle, the meniscus vibration caused in one driving cycle may not be sufficiently attenuated before the next driving cycle starts. The amount of ink to be injected to form a small dot is smaller than the amount of ink to be injected to form a large dot. Therefore, the influence of the remaining meniscus vibration on the operation of injecting the ink to form a small dot is larger than the influence thereof on the operation of injecting the ink to form a large dot. However, in this preferred embodiment, the driving pulse P1 included in the dedicated large dot driving signal W3 is generated before the small dot driving signal W1 and the medium dot driving signal W2. Therefore, as shown in FIG. 6A, for forming a small dot, the reference potential V0 is maintained for at least a time period corresponding to the pulse width of the driving pulse P1 before the initial driving pulse P2 is supplied to the actuator 26. Therefore, even if the meniscus vibration remains at the time of start of the driving cycle, the meniscus vibration is attenuated sufficiently before the initial driving pulse P2 of the small dot driving signal W1 is supplied. Thus, a small amount of ink is injected accurately and stably, and a small dot is formed stably on the recording paper sheet 5. Similarly, a medium dot is formed stably on the recording paper sheet 5. In this preferred embodiment, a small dot and a medium dot are formed stably in this manner. This increases the degree of designing freedom of the small dot driving signal W1 and the medium dot driving signal W2.

As described above, the inkjet printer 10 in this preferred embodiment forms a large dot, a medium dot and a small dot stably on the recording paper sheet 5 by the driving signal designed with a high degree of freedom. With the designing method in this preferred embodiment, a driving signal used to stably form a large dot, a medium dot and a small dot, each having a desired size, on the recording paper sheet 5 is designed easily.

In this preferred embodiment, the small dot driving signal W1 is generated before the medium dot driving signal W2. The waveform of the small dot driving signal W1 is simpler than the waveform of the medium dot driving signal W2. Therefore, even if the driving pulse P1 included in the dedicated large dot driving signal W3 is supplied immediately before the small dot driving signal W1 in order to form a large dot, an ink drop (the first ink drop described above) is injected by the driving pulse P1 and then the next ink drop (the second ink drop described above) is injected stably by the small dot driving signal W1. In this manner, a large dot is formed more stably. Since the large dot is formed more stably, the degree of designing freedom of the dedicated large dot driving signal W3 is increased.

In this preferred embodiment, the driving signal generation circuit 31 does not generate a driving pulse included in the dedicated large dot driving signal W3 between the small dot driving signal W1 and the medium dot driving signal W2. In this preferred embodiment, the dedicated large dot driving signal W3 includes only one driving pulse P1. Therefore, the entire waveform of the driving signal generated by the driving signal generation circuit 31 is shortened, and thus the time period of one driving cycle is shortened. This increases the printing speed.

In this preferred embodiment, the small dot driving signal W1 includes one driving pulse (driving pulse P2) decreasing, and then increasing, the pressure of the ink in the pressure chamber 23, and the medium dot driving signal W2 includes two driving pulses (driving pulses P4 and P5) decreasing, and then increasing, the pressure of the ink in the pressure chamber 23. With this arrangement, the operation of injecting the ink from the nozzle 25 is performed once in order to form a small dot, and the operation of injecting the ink from the nozzle 25 is performed twice in order to form a medium dot. In this preferred embodiment, a small dot and a medium dot are formed stably on the recording paper sheet 5.

Preferred embodiments of the present invention have been described above. The above-described preferred embodiments are merely examples, and the present invention may be carried out in any of various other preferred embodiments.

In the above-described preferred embodiments, three types of dots having different sizes preferably are formed on the recording paper sheet 5. Preferred embodiments of the present invention are applicable to any liquid injection device forming at least three types of dots having different sizes on a target. The liquid injection devices according to various preferred embodiments of the present invention may form four or more types of dots having different sizes.

In the above-described preferred embodiments, the actuator is preferably a longitudinal vibration mode piezoelectric element, for example. The actuator is not limited to this. The actuator may be a transverse vibration mode piezoelectric element. The actuator is not limited to a piezoelectric element, and may be, for example, a magnetostrictive element.

In the above-described preferred embodiments, the liquid is preferably ink, for example. The liquid is not limited to this. The liquid may be, for example, a resin material, any of various liquid compositions containing a solute and a solvent (e.g., washing liquid), or the like.

In the above-described preferred embodiments, the injection head is preferably the injection head 15 mountable on the inkjet printer, for example. The injection head is not limited to this. The injection head may be mountable on, for example, any of various production devices of an inkjet system, a measuring device such as a micropipette, or the like, to be usable in any of various uses.

The terms and expressions used herein are for description only and are not to be interpreted in a limited sense. These terms and expressions should be recognized as not excluding any equivalents to the elements shown and described herein and as allowing any modification encompassed in the scope of the claims. The present invention may be embodied in many various forms. This disclosure should be regarded as providing preferred embodiments of the principles of the present invention. These preferred embodiments are provided with the understanding that they are not intended to limit the present invention to the preferred embodiments described in the specification and/or shown in the drawings. The present invention is not limited to the preferred embodiments described herein. The present invention encompasses any of preferred embodiments including equivalent elements, modifications, deletions, combinations, improvements and/or alterations which can be recognized by a person of ordinary skill in the art based on the disclosure. The elements of each claim should be interpreted broadly based on the terms used in the claim, and should not be limited to any of the preferred embodiments described in this specification or referred to during the prosecution of the present application.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A liquid injection device, comprising:
a case accommodating a pressure chamber storing a liquid;
a vibration plate provided in the case, the vibration plate demarcating a portion of the pressure chamber;
an actuator coupled with the vibration plate, the actuator being deformed by an electric signal supplied thereto;
a nozzle provided in the case, the nozzle being in communication with the pressure chamber;
a driving signal generation circuit generating, at every driving cycle, a driving signal including a small dot driving signal, a medium dot driving signal and a dedicated large dot driving signal, the small dot driving signal, the medium dot driving signal and the dedicated large dot driving signal each including at least one driving pulse; and
a driving signal supply circuit supplying a portion of, or an entirety of, the driving signal generated by the driving signal generation circuit to the actuator; wherein
the driving signal generation circuit generates the at least one driving pulse included in the dedicated large dot driving signal before the small dot driving signal and the medium dot driving signal; and
the driving signal supply circuit includes:
a small dot supplier supplying the small dot driving signal to the actuator;
a medium dot supplier supplying the medium dot driving signal, and not supplying the small dot driving signal, to the actuator; and
a large dot supplier supplying the small dot driving signal, the medium dot driving signal and the dedicated large dot driving signal to the actuator.

2. The liquid injection device according to claim 1, wherein the driving signal generation circuit generates the small dot driving signal before generating the medium dot driving signal.

3. The liquid injection device according to claim 1, wherein the driving signal generation circuit generates no driving pulse included in the dedicated large dot driving signal between the small dot driving signal and the medium dot driving signal.

4. The liquid injection device according to claim 1, wherein the dedicated large dot driving signal includes one driving pulse.

5. The liquid injection device according to claim 1, wherein
the small dot driving signal includes one driving pulse decreasing, and then increasing, a pressure of a liquid in the pressure chamber; and
the medium dot driving signal includes two driving pulses decreasing, and then increasing, the pressure of the liquid in the pressure chamber.

6. An inkjet printer, comprising:
the liquid injection device according to claim 1;
wherein the liquid is ink.

7. A method for generating a driving signal for the liquid injection device according to claim 1, the method comprising:
determining a number of the at least one driving pulse to be included in the small dot driving signal, a number of the at least one driving pulse to be included in the medium dot driving signal, and a number of the at least one driving pulse to be included in the dedicated large dot driving signal;
determining an order of all of the at least one driving pulse to be included in the small dot driving signal, the at least one driving pulse to be included in the medium dot driving signal, and the at least one driving pulse to be included in the dedicated large dot driving signal;
determining a potential and a pulse width of each of the at least one driving pulse to be included in the small dot driving signal, each of the at least one driving pulse to be included in the medium dot driving signal and each of the at least one driving pulse to be included in the dedicated large dot driving signal;
after the determining the number of the driving pulses, the determining the order of the driving pulses, and the determining the potential and the pulse width, supplying the small dot driving signal to the actuator to inject the liquid from the nozzle to form a small dot on a target, supplying the medium dot driving signal to the actuator to inject the liquid from the nozzle to form a medium dot on the target, and supplying the small dot driving signal, the medium dot driving signal and the dedicated large dot driving signal to the actuator to inject the liquid from the nozzle to form a large dot on the target;
measuring a size of each of the small dot, the medium dot and
the large dot; and
adjusting the potential and/or the pulse width of each of the at least one driving pulse included in the small dot driving signal, each of the at least one driving pulse included in the medium dot driving signal and each of the at least one driving pulse included in the dedicated large dot driving signal, based on the measured size of each of the small dot, the medium dot and the large dot.

8. A method for generating a driving signal for the liquid injection device according to claim 1, the method comprising:
designing a waveform of each of the small dot driving signal and the medium dot driving signal; and
designing a waveform of the dedicated large dot driving signal such that a large dot of a predetermined size is formed on a target by supplying, to the actuator, the dedicated large dot driving signal, the small dot driving signal and the medium dot driving signal.
